(19) United States
(12) Patent Application Publication
(10) Pub. No.: US 2026/0192743 A1
(43) Pub. Date: Jul. 9, 2026

(54) HIGH MOUNT STOP LAMP AND BRAKE SYSTEM FOR VEHICLES

(71) Applicant: Shenzhen Shenhang Huachuang Automobile Technology Co., Ltd., Shenzhen (CN)

(72) Inventor: GUANFU HUANG, Qiannan Buyi and Miao Autonomous Prefect (CN)

(21) Appl. No.: 19/557,424

(22) Filed: Mar. 5, 2026

(51) Int. Cl. B60Q 1/46; B60Q 1/00; B60Q 1/26; B60Q 1/44; H05B 45/325; H05B 45/46

(52) U.S. Cl. CPC B60Q 1/46; B60Q 1/0094; B60Q 1/2696; B60Q 1/44; H05B 45/325; H05B 45/46

(57) ABSTRACT

Provided are a high mount stop lamp and a brake system for vehicles. The high mount stop lamp includes an LED light group, a power input interface, and a control circuit board. The power input interface integrates a communication protocol pin. The control circuit board includes a current limiting circuit, a flashing control circuit, and a main control unit. The flashing control circuit is connected to the current limiting circuit and the power input interface. The current limiting circuit is connected to the LED light group, and the main control unit is connected to the flashing control circuit and the communication protocol pin and configured to control the flashing control circuit to output a continuous constant current or high-frequency on/off constant current to the LED light group to drive the LED light group to switch between a constant light warning mode and a super flashing warning mode.

### TECHNICAL FIELD

The present disclosure relates to the field of vehicle electronics technologies, and in particular, to a high mount stop lamp and a brake system for vehicles.

### BACKGROUND

With the continuous growth of car ownership, road safety, especially the prevention of rear end collisions, has become increasingly important. The High Mount Stop Lamp (HMSL) is an important passive safety signal device for vehicles. Its function is to provide a prominent and high warning light signal to the rear vehicle when braking to reduce the risk of rear end collision. However, traditional high mount stop lamps have a single function, and most products only have basic lighting and extinguishing functions. In poor visibility weather conditions such as rain, fog, and haze, their penetration and warning effects are significantly weakened, rendering it difficult to attract the full attention of a driver behind.

### SUMMARY

The technical problem to be solved by the present disclosure is to provide a high mount stop lamp with a constant light warning mode and a super flashing warning mode, which can switch between the super flashing warning mode and improve a warning effect in low visibility and adverse weather conditions such as rain, fog, and haze to address the shortcomings of the existing high mount stop lamp with a single function and limited warning effect.

In a first aspect, an embodiment of the present disclosure provides a high mount stop lamp of a vehicle, including:
a light-emitting diode, (LED) light group;
a power input interface, configured to connect to a vehicle power supply and integrated with a communication protocol pin to receive a mode switching signal output by a vehicle front-end host;
a control circuit board, including a current limiting circuit, a flashing control circuit, and a main control unit; the flashing control circuit is connected to the current limiting circuit and the power input interface, respectively; the current limiting circuit is connected to the LED light group, and the main control unit is connected to the flashing control circuit and the communication protocol pin, respectively and configured to control the flashing control circuit to output a continuous constant current or a high-frequency on/off constant current to the LED light group according to the mode switching signal so as to drive the LED light group to switch between a constant light warning mode or a super flashing warning mode accordingly.

In a second aspect, an embodiment of the present disclosure provides a braking system for a vehicle, including a vehicle front end host and the high mount stop lamp for a vehicle as described in any one of the above.

Beneficial effects: an embodiment of the present disclosure provides a high mount stop lamp for vehicles, including an LED light group, a power input interface, and a control circuit board. The power input interface integrates the communication protocol pin to receive the mode switching signal output by the vehicle front-end host. The control circuit board includes a current limiting circuit, a flashing control circuit, and a main control unit. The flashing control circuit is connected to the current limiting circuit and the power input interface respectively. The current limiting circuit is connected to the LED light group, and the main control unit is connected to the flashing control circuit and the communication protocol pin respectively and is configured to control the flashing control circuit to output a continuous constant current or a high-frequency on/off constant current to the LED light group according to the mode switching signal so as to drive the LED light group to switch between the constant light warning mode and the super flashing warning mode accordingly. Therefore, the super flashing warning mode can be switched in low visibility and adverse weather conditions such as rain, fog, and haze, and the warning effect can be improved.

### BRIEF DESCRIPTION OF DRAWINGS

Combining with the accompanying drawings, a detailed description of the specific implementation mode of the present application will make the technical solution and its beneficial effects obvious.

FIG. 1 is a schematic structural diagram of a high mount stop lamp of a vehicle according to the present disclosure.

FIG. 2 is a schematic diagram of a partial circuit of a control circuit board connected to an LED light group of the present disclosure.

FIG. 3 is a schematic diagram of a connection between a lens module and a vehicle rearview mirror of the present disclosure.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that the specific embodiments described herein are only for explaining the present disclosure and are not intended to limit the present disclosure.

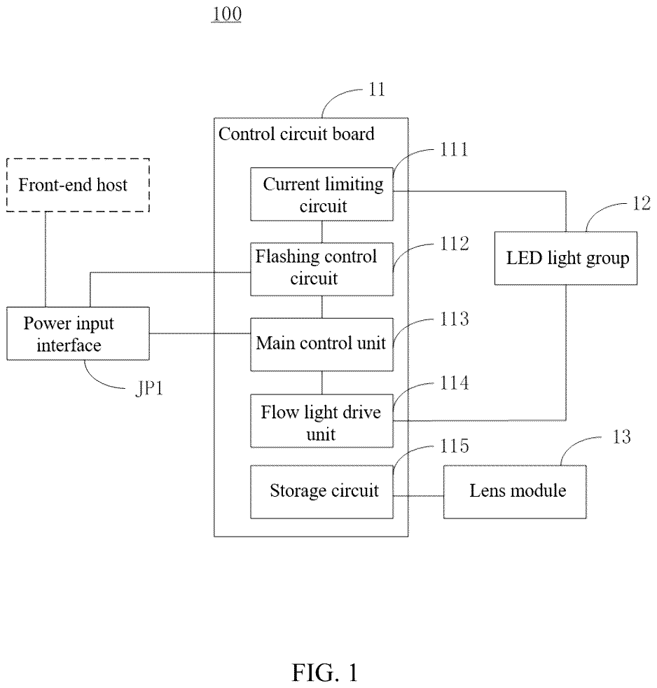

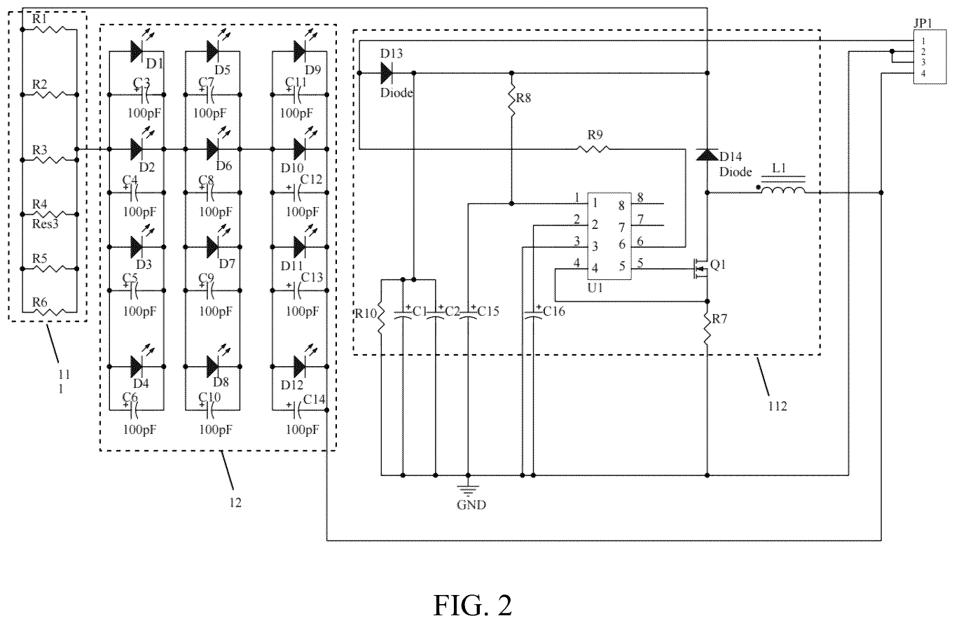

Referring to FIGS. 1 and 2, an embodiment of the present disclosure provides a high mount stop lamp 100 for a vehicle, including a housing, a power input interface JP1, a control circuit board 11, and an LED light group 12.

The control circuit board 11 is provided inside the housing, and the power input interface JP1 and the LED light group 12 are both located on the control circuit board 11. The housing is made of high-strength engineering plastic or metal material, and joints are completely sealed with silicone sealing rings and sealant to ensure an IP68 protection level, which can effectively prevent rainwater, dust, and high-pressure water flow from car washing from entering.

Where the power input interface JP1 is configured to connect to a vehicle power supply, usually 12V Direct Current, (DC). The power input interface JP1 integrates a communication protocol pin to receive a mode switching signal output by a vehicle front-end host, which can be implemented using a vehicle standard four pin connector.

The control circuit board 11 includes a current limiting circuit 111, a flashing control circuit 112, and a main control unit 113. The flashing control circuit 112 is respectively connected to the current limiting circuit 111 and the power input interface JP1. The LED light group 12 is connected to the current limiting circuit 111. The main control unit 113 is respectively connected to the flashing control circuit 112 and the communication protocol pin, configured to control the flashing control circuit 112 to output a continuous constant current or a high-frequency on/off constant current to the LED light group 12 according to a mode switching signal, to drive the LED light group 12 to switch between a constant light warning mode or a super flashing warning mode accordingly.

Where the constant light warning mode corresponds to a basic brake lighting function, and the super flashing warning mode causes the LED light group to enter a high-frequency flashing state when the brake is triggered. Therefore, in poor visibility weather conditions such as rain, fog, and haze, a user can switch to the super flashing warning mode to improve the warning effect.

In an implementation mode of the present disclosure, the vehicle front-end host may be a central control device of the vehicle, having a mode switching key or a user interaction interface, where the user interaction interface provides a switching button, and the user can trigger the vehicle front-end host to output the mode switching signal by pressing the switching key or switching button. For example, in rainy and foggy weather, the user can trigger the high mount stop lamp to switch to the super flashing warning mode by switching the key.

Referring to FIG. 2, the flashing control circuit 112 includes a control chip U1, a transistor Q1, an energy storage inductor L1, an isolation diode D13, a freewheeling diode D14, a resistor R7, a resistor R8, a resistor R9, a resistor R10, a capacitor C1, a capacitor C2, a capacitor C15, and a capacitor C16. Where, a 7^{th} pin of the control chip U1 is an enable terminal, which is connected to the main control unit 113. A 1^{st} pin of the power input interface JP1 is connected to a voltage of the vehicle power supply and is connected to a positive terminal of the isolation diode D13. A 2^{nd} pin and a 3^{rd} pin of the power input interface JP1 are grounded, and a 4^{th} pin of the power input interface JP1 is the communication protocol pin. The LED light group 12 includes at least 3 columns of LED substrings connected in series, each column of LED substrings consisting of multiple LED lights connected in parallel. In an implementation mode, the LED light group 12 adopts a topology structure of “parallel connection within columns and series connection between columns”, which includes 3 columns of LED substrings connected in series. Each column of LED substrings is composed of 4 LED beads that are connected in parallel, namely a left column LED lights D1-D4, a middle column LED lights D5-D8, and a right column LED lights D9-D12. By parallel connecting LED beads within the column, when one single LED bead is damaged, it does not affect the operation of the entire sub string, thus improving the redundancy and reliability of the lamp group. By connecting columns in series, intercolumn voltage division can be achieved, allowing the total rated voltage of LED light group 12 to adapt to the vehicle's power supply voltage without the need for additional voltage reduction circuits. The current limiting circuit 111 includes a voltage divider resistor network composed of a resistor R1, a resistor R2, a resistor R3, a resistor R4, a resistor R5, and a resistor R6, and capacitors connected in parallel at two ends of each LED lamp.

The specific circuit connection relationship of each component can refer to the circuit schematic shown in FIG. 2, and will not be elaborated here.

Where the flashing control circuit 112 mainly boosts the 12V voltage of the vehicle power supply to a stable voltage suitable for the LED light group 12, and outputs the continuous constant current or high-frequency on-off constant current. Its working principle is divided into a boosting stage and a constant current control stage:
In the boosting stage, a 5^{th} pin of the control chip U1 outputs a high-level Pulse Width Modulation, (PWM) drive signal, controlling Q1 to conduct. At this time, the 12V input voltage forms a loop through the energy storage inductor L1 and the transistor Q1, and the energy storage inductor L1 gradually increases in current to store magnetic energy. When the 5^{th} pin of the control chip U1 outputs a low-level PWM drive signal, the transistor Q1 is turned off, and the energy storage inductor L1 generates a reverse induced electromotive force (with a polarity of positive up and negative down). This induced electromotive force is superimposed with the vehicle's 12V input voltage to form an output voltage higher than the 12V input voltage. The output voltage after superposition is output to the current limiting circuit 111 through the isolation diode D13, which supplies power to the LED lamp group 12. The freewheeling diode D14 conducts at this stage, thereby providing a freewheeling circuit for the reverse current of the energy storage inductor L1, thereby avoiding a breakdown of the transistor Q1 due to high reverse voltage.

The current sampling resistor R7 collects a working current and generates a voltage drop Vcs, which is transmitted to a 4^{th} pin of the control chip U1. A comparator inside the control chip U1 compares the voltage drop Vcs with a preset reference voltage. If Vcs is greater than the reference voltage (the current is too large), a duty cycle of the output PWM drive signal is reduced, a conduction time of the transistor Q1 is reduced, and the current of the energy storage inductor L1 is reduced. If Vcs<reference voltage (the current too small), the duty cycle of the PWM drive signal is increased, the current is increased, and constant current control is achieved.

Where resistor R8 and resistor R9 form a voltage divider circuit to collect an output voltage (Vout) of the flashing control circuit 112, and transmit a divided voltage signal Vfb to a 6^{th} pin of the control chip U1. The control chip U1 compares the voltage signal Vfb with an internal reference voltage. If Vfb is greater than the reference voltage (high voltage), the output of the transistor Q1 is immediately turned off to achieve overvoltage protection.

In an implementation mode of the present disclosure, the high mount stop lamp 100 further includes a lens module 13, which is connected to the control circuit board 11 for capturing rear scene images of the vehicle, thereby automatically recording the rear scene before and after the accident. By embedding the lens module 13 into the high mount stop lamp 100, it is possible to avoid the lens module 13 being easily scratched, thereby protecting the lens module 13 and ensuring its shooting angle, and reducing a space occupied by the lens module 13 in a rear of the vehicle. In an implementation mode, the control circuit board 11 further includes a storage circuit 115, such as a TF card storage module. The storage circuit 115 is connected to the lens module 13 and is configured to store the rear scene images of the vehicle captured by the lens module 13.

Where the lens module 13 can be connected to the control circuit board 11 through FPC (flexible circuit board) or a connector, and it can be installed on the housing, located above or on one side of the LED light group 12. A lens window and a transparent cover of the lens module 13 adopt integrated injection molding or seamless bonding process to ensure the integrity and sealing of the appearance. In other embodiments, the lens module 13 can also be directly integrated onto the control circuit board 11 through surface mount technology.

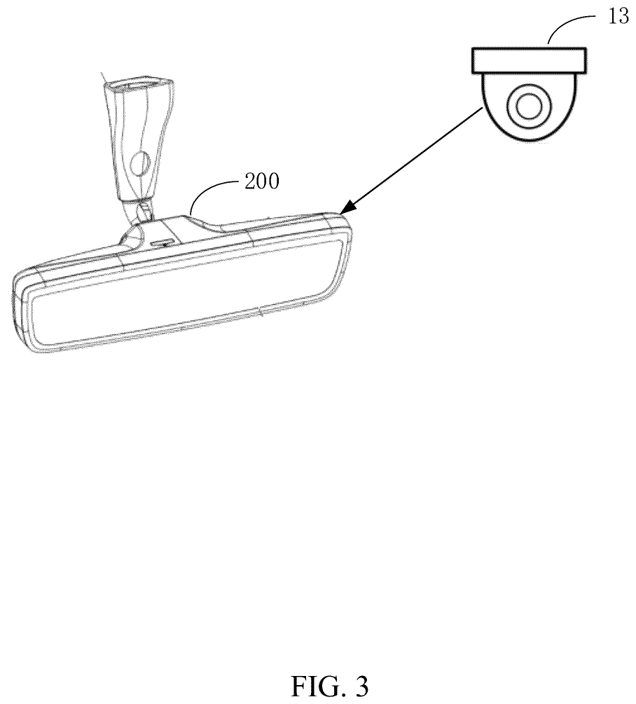

In an implementation mode of the present disclosure, as shown in FIG. 3, the vehicle front-end host the can also be a vehicle rearview mirror 200, which is provided with a mode switching key or a switching button on a display interface of the vehicle rearview mirror 200. The mode switching of the high mount stop lamp 100 can be achieved through the switching key or switching button. And the lens module 13 can also transmit the collected rear scene images of the vehicle to the vehicle rearview mirror 200 for real-time display, assisting the driver in monitoring road conditions behind and eliminating blind spots in the field of view. In an implementation mode, the vehicle front-end host is a vehicle central control device, and the lens module 13 can also establish a communication connection with the front-end host to transmit the collected rear scene images of the vehicle to the screen of the vehicle front-end host for display.

In an implementation mode, the control circuit board 11 further includes a flow light drive unit 114, and the flow light drive unit 114 is connected to the main control unit 113 and the LED light group 12. The flow light drive unit 114 is configured to receive a timing control signal output by the main control unit 113 and drive at least some of the light beads in the LED light group 12 to light up sequentially according to the timing control signal to achieve the flow light effect. The timing control signal is generated by the vehicle front-end host in response to a vehicle brake signal or a turn signal, and is transmitted to the main control unit 113 through the communication protocol pin. Where the flowing light drive unit 114 includes a multi-channel switch or a shift register. Under the action of the timing control signal, multiple LED beads in the LED light group 12 can be gradually lit up through the multi-channel switch or shift register.

The working principle of the high mount stop lamp in the embodiments of the present disclosure will be further described below.

After the vehicle is ignited or powered on, the vehicle power supply is used to power a brake light. The brake light 100 defaults to a normal warning mode. At this time, when the driver presses a brake pedal, the LED light group 12 is in the constant warning mode.

The driver can select a working mode of the high mount stop lamp through the switch button on the vehicle's central control device or menu options on the user interaction interface. After receiving the user's selection, the front-end host generates a mode switching signal and sends it to the power input interface JP1 through wiring harness. The main control unit 113 receives the mode switching signal through the communication protocol pin and outputs an adjustment signal to the control chip U1 of the flashing control circuit 112 according to the mode switching signal, so that the control chip U1 adjusts the output PWM driving signal, enabling the LED light group 12 to switch between the constant light warning mode and the super flashing warning mode.

Specifically, in the constant light warning mode, the main control unit 113 outputs a stable high-level adjustment signal or a PWM adjustment signal with a fixed duty cycle to the enable terminal (i.e., 7^{th} pin) of the control chip U1, so that the control chip U1 outputs a PWM driving signal with a stable frequency (e.g., 100 KHZ), and then the transistor Q1 is regularly turned on/off at the fixed frequency, so that the flashing control circuit 112 outputs a continuous constant current to the LED light group 12, achieving constant brightness of the LED light group 12. In the super flashing warning mode, the main control unit 113 outputs a high-frequency (e.g. 10 Hz-20 Hz) PWM adjustment signal to the enable terminal of the control chip U1. The control chip U1 maintains the basic switching frequency of 100 kHz unchanged, and only enables the output of the high-frequency PWM adjustment signal from the main control unit 113, that is, the control chip U1 maintains the PWM drive signal of 100 kHz unchanged. The main control unit 113 modulates the output of the PWM drive signal with a low-frequency cycle of 10-20 Hz to “enable/disable output”, thereby achieving high-frequency on-off of the transistor Q1 at 10-20 Hz. As a result, the flashing control circuit 112 outputs a constant current of high-frequency on-off to the LED light group 12, achieving the flash warning effect of the LED light group 12.

Furthermore, the flowing light effect can be added in both the constant light warning mode and the super flashing warning mode. When the brake is triggered, the front-end host will also send a timing control signal to the main control unit 113 through the communication protocol pin. The control chip U1 controls the LED light group 12 to stay on or flash, and the flow light drive unit 114 controls some or all LED light groups in the LED light group 12 to light up sequentially according to the timing control signal. For example, starting from the LED light in the middle column, it lights up sequentially to the two outermost columns of LED lights, as if the light waves are spreading to two sides, greatly enhancing the dynamic warning effect.

Furthermore, the high mount stop lamp 100 of the embodiment of the present disclosure can also be used for steering indication. It can be understood that in practical applications, there are two high mount stop lamps 100 provided at a rear of the vehicle, located on left and right sides of the rear of the vehicle. When the driver turns on a turn signal, such as the left turn signal, the left turn signal is obtained by the front-end host through a vehicle bus. The front-end host generates a timing control signal and sends the left turn signal and timing control signal to the main control unit 113. After the main control unit 113 in the high mount stop lamp 100 located on the left side of the vehicle parsed the left turn signal, it first drives the LED light group 12 to light up through the control chip U1, for example, it is always on. Then, according to the timing control signal, the flow light drive unit drives the LED beads to light up in sequence. For example, it controls the three columns of LED substrings to light up in the order of L1 to L2 and to D3, with an interval of 80 milliseconds between each column, and then turns off sequentially. This cycle forms a light strip that flows to the left. At this time, the main control unit 113 in the high mount stop lamp 100 provided on the right side of the vehicle interprets the left turn signal and does not trigger the LED light group in the high mount stop lamp 100 on the right side to light up.

Where when the brake signal and turn signal are triggered simultaneously, the corresponding light mode of the brake is prioritized, that is, the high mount stop lamps on two sides are constantly on or flashing at the same time, and the flowing light effect can be superimposed.

In some embodiments of the present disclosure, the front-end host integrates visual algorithms that can roughly estimate a distance of a rear vehicle based on image data collected by the lens module 13. When it is determined that the rear vehicle is approaching quickly and there is a risk of collision, the front-end host can send a highest priority “emergency flash” command to the main control unit 113 through the power input interface JP1. At this point, regardless of the mode in which the LED light group 12 is in, the control chip U1 will force the LED light group 12 to flash at the highest frequency and brightness as an additional active collision warning, further enhancing safety.

An embodiment of the present disclosure further provides a vehicle braking system, including a vehicle front-end host and the high mount stop lamp 100 described in the above embodiments. The front-end host of the vehicle can be the central control device or the vehicle rearview mirror.

This specification uses specific examples to explain the principles and implementation modes of the present application. The above examples are only used to help understand the methods and core ideas of the present application. For those skilled in the art, there may be changes in the specific implementation modes and application scope based on the ideas of this application. In summary, the content of this specification should not be understood as limiting this application.

What is claimed is:

1. A high mount stop lamp of a vehicle, comprising:
a LED light group;
a power input interface, configured to connect to a vehicle power supply and integrated with a communication protocol pin to receive a mode switching signal output by a vehicle front-end host;
a control circuit board, comprising a current limiting circuit, a flashing control circuit, and a main control unit; the flashing control circuit is connected to the current limiting circuit and the power input interface, respectively; the current limiting circuit is connected to the LED light group, and the main control unit is connected to the flashing control circuit and the communication protocol pin, respectively and configured to control the flashing control circuit to output a continuous constant current or a high-frequency on/off constant current to the LED light group according to the mode switching signal so as to drive the LED light group to switch between a constant light warning mode or a super flashing warning mode accordingly.

2. The high mount stop lamp of a vehicle according to claim 1, further comprises a lens module that is connected to the control circuit board and is configured to capture rear scene images of the vehicle.

3. The high mount stop lamp of a vehicle according to claim 2, wherein the control circuit board further comprises a storage circuit, and the storage circuit is connected to the lens module and configured to store the rear scene images of the vehicle captured by the lens module.

4. The high mount stop lamp of a vehicle according to claim 1, wherein the control circuit board further comprises a flow light drive unit, and the flow light drive unit is connected to the main control unit and the LED light group, and is configured to receive a timing control signal output by the main control unit, and drive at least some LED beads in the LED light group to light up sequentially according to the timing control signal,
wherein the timing control signal is generated by the vehicle front-end host in response to a vehicle brake signal or a turn signal, and is transmitted to the main control unit through the communication protocol pin.

5. The high mount stop lamp of a vehicle according to claim 1, wherein the flashing control circuit comprises a control chip U1, a transistor Q1, an energy storage inductor L1, an isolation diode D13, a freewheeling diode D14, a current sampling resistor R7, a resistor R8, a voltage divider resistor R9, a resistor R10, a capacitor C1, a capacitor C2, a capacitor C15, and a capacitor C16;
a 1^{st} pin of the control chip U1 is grounded through the capacitor C15, a 2^{nd} pin of the control chip U1 is grounded through the capacitor C16, a 3^{rd} pin of the control chip U1 is grounded, a 4^{th} pin of the control chip U1 is connected to a source electrode of the transistor Q1, a 5^{th} pin of the control chip U1 is connected to a gate electrode of the transistor Q1, a 6^{th} pin of the control chip U1 is connected to a positive electrode of the isolation diode D13 through the voltage divider resistor R9, a 7^{th} pin of the control chip U1 is connected to the main control unit, a source electrode of the transistor Q1 is grounded through the current sampling resistor R7, a drain electrode of the transistor Q1 is connected to a positive electrode of the freewheeling diode D14 and one end of the energy storage inductor L1; and a negative electrode of the freewheeling diode D14 is connected to a negative electrode of the isolation diode D13 to the current limiting circuit,
the resistor R8 is connected between the negative terminal of the isolation diode D13 and the 1^{st} pin of the control chip U1,
the resistor R10, capacitor C1, and capacitor C2 are connected parallel between the negative electrode and a ground terminal of the isolation diode D13,
the other end of the energy storage inductor L1 is connected to the communication protocol pin.

6. The high mount stop lamp of a vehicle according to claim 5, wherein a 1^{st} pin of the power input interface is connected to the vehicle power supply and is connected to the positive terminal of the isolation diode D13, a 2^{nd} pin and a 3^{rd} pin of the power input interface are grounded, and a 4^{th} pin of the power input interface is the communication protocol pin.

7. The high mount stop lamp of a vehicle according to claim 5, wherein the LED light group comprises at least 3 columns of LED substrings that are connected in series, and each column of LED substrings is composed of multiple LED lights connected in parallel;
the current limiting circuit comprises a voltage divider resistor network composed of a resistor R1, a resistor R2, a resistor R3, a resistor R4, a resistor R5, and a resistor R6, and capacitors connected in parallel at two ends of each LED lamp.

8. The high mount stop lamp of a vehicle according to claim 1, further comprises a housing, wherein the control circuit board is provided inside the housing, and the power input interface, the LED light group, and the main control unit are all integrated on the control circuit board.

9. A braking system for a vehicle, comprising: a vehicle front end host and a vehicle high mount stop lamp according to claim 1.
